(19) United States
(12) Patent Application Publication
(10) Pub. No.: US 2010/0128050 A1
(43) Pub. Date: May 27, 2010

(54) Color Correction Method and Related Device for Liquid Crystal Display

(76) Inventors: Chun-Hsien Chou, Taipei City (TW); Ray-Chin Wu, Taipei City (TW); Chih-Cheng Fu, Taipei City (TW); Cheng-Chieh Wu, Taipei City (TW); Jia-Ming Huang, Yilan City (TW)

Correspondence Address: NORTH AMERICA INTELLECTUAL PROPERTY CORPORATION, P.O. BOX 506, MERRIFIELD, VA, 22116, US

(21) Appl. No.: 12/364,483

(22) Filed: Feb. 2, 2009

(30) Foreign Application Priority Data
Nov. 21, 2008 (TW) 097145135

(51) Int. Cl. G09G 5/02

(52) U.S. Cl. 345/589

(57) ABSTRACT

A color correction method for liquid crystal displays (LCDs) is provided to eliminate crosstalk among color channels of the LCDs in the present invention. The color correction method includes steps of utilizing a channel-dependent Gain-Offset-Gamma (GOG) model to characterize a non-linear Electro-Optical Transfer Function (EOTF) of the LCDs in which crosstalk among color channels exists, converting the non-linear EOTF into a device-independent linear EOTF and modifying the linear EOTF to a target EOTF, so as to make the LCDs have expected colorimetry.

### BACKGROUND OF THE INVENTION

1. Field of the Invention

The present invention relates to a color correction method for liquid crystal displays (LCDs) and related color correction device, and more particularly, to a color correction method of using gain parameters and gamma parameters of a Gain-Offset-Gamma (GOG) model to measure channel interactions or crosstalk existing among three primary colors for accurately estimating colorimetry of the LCDs and related color correction device.

2. Description of the Prior Art

For achieving apparatus-independent color reproduction, accurate colorimetry measurement is an important step when establishing color management systems of display devices. Thus, the prior art, based on displaying theory of Cathode Ray Tube (CRT) monitors, provides a Gain-Offset-Gamma (GOG) model to characterize a Tone Reproduction Curve (TRC) or an Electro-Optical Transfer Function (EOTF) of each primary color for estimating colorimetry of the display devices. Regarding the CRT monitors, the GOG model is already effective in characterizing the TRCs.

However, as technology has evolved, Liquid Crystal Displays (LCDs) have replaced the CRT monitors and become increasingly popular on the display markets. Since display features of the LCDs differ from the CRT monitors, there usually exist channel interactions, or crosstalk, among three primary colors of the LCDs. Therefore, the GOG model simulated with constant gain parameters and constant gamma parameters can no longer accurately estimate the colorimetry of the LCDs, especially, for Color Sequential Display (CSD) LCDs. In this situation, even after performing color correction on input signals of the LCDs, the LCDs are still not able to have precise color performance due to their inherent colorimetry.

To put it simply, the conventional GOG model is not suitable for the LCDs due to presence of channel interactions and color inconstancy.

### SUMMARY OF THE INVENTION

It is therefore an objective of the present invention to provide a color correction method for liquid crystal displays (LCDs) and related color correction device.

The present invention discloses a color correction method for eliminating crosstalk between color channels of LCDs. The color correction method includes establishing a channel-dependent Gain-Offset-Gamma (GOG) model to characterize an Electro-Optical Transfer Function (EOTF) of each primary color in which a gain parameter and a gamma parameter of each primary color vary with inputs of other two primary colors due to crosstalk among color channels, measuring the EOTF of each primary color when the other two primary colors are under different input conditions, and simulating the gain parameter and the gamma parameter of each primary color by use of a first surface function and a second surface function, substituting inputs of the three primary colors into the first surface function and the second surface function to calculate the gain parameter and the gamma parameter of each primary color for further estimation of a non-linear EOTF of each primary color and linearizing the non-linear EOTF of each primary color through inverse transformation of the channel-dependent GOG model, and performing color correction according to a target colorimetry to obtain corrected values of the three primary colors.

The present invention further discloses a color correction device for eliminating crosstalk among color channels of LCDs. The color correction device includes a quantization unit, an estimation unit, and a correction unit. The quantization unit is used for individually quantizing inputs of three primary colors. The estimation unit is coupled to the quantization unit, and used for performing look-up table operation according to quantization results of the inputs of each primary color to generate a gain parameter and a gamma parameter of each primary color for further estimation of a non-linear EOTF of each primary color. The gain parameter and the gamma parameter of each primary color vary with the inputs of the other two primary colors due to crosstalk among color channels. The estimation unit includes at least one gamma look-up table (LUT) and at least one gain LUT. At least one gamma LUT is used for storing all possible values of the gamma parameter of each primary color under conditions of all possible quantization results of the other two primary colors. At least one gain LUT is used for storing all possible values of the gain parameter of each primary color under conditions of all possible quantization results of the other two primary colors. The correction unit is coupled to input terminals of the quantization unit and the estimation unit, and used for performing color correction on the input of each primary color according to the gain parameter and the gamma parameter of each primary color to generate corrected values of the three primary colors meeting a target colorimetry. The correction unit includes at least one correction LUT which is used for storing all calculation results of the color correction for all possible inputs of the three primary colors.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of a color correction process for a liquid crystal display (LCD) according to an embodiment of the present invention.

FIG. 2 is a schematic diagram of a color correction process according to an embodiment of the present invention.

FIG. 3˜FIG. 5 are schematic diagrams of a color correction device for an LCD according to an embodiment of the present invention.

### DETAILED DESCRIPTION

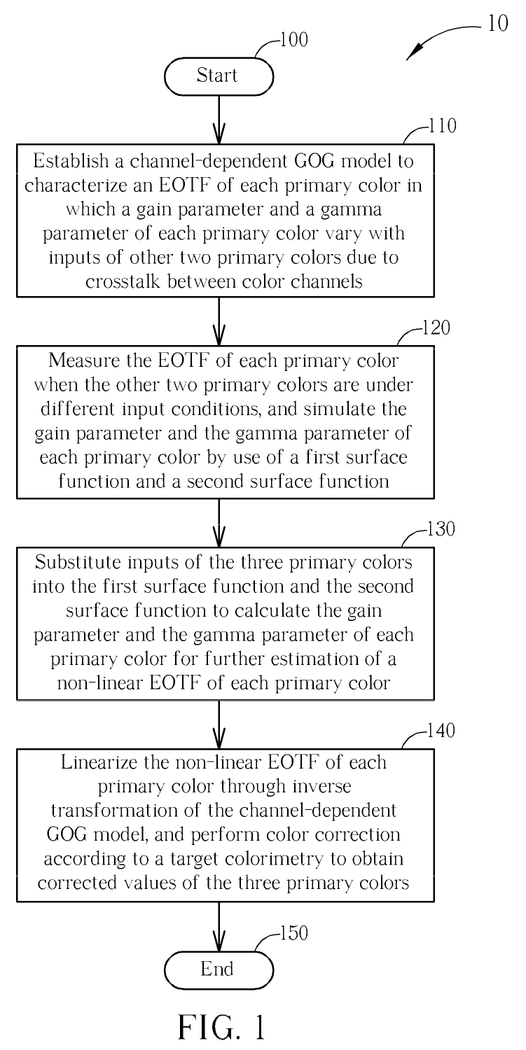

Please refer to FIG. 1, which is a flowchart of a color correction process 10 for a liquid crystal display (LCD) according to an embodiment of the present invention. The color correction process 10 is used for performing color correction for the LCD to eliminate crosstalk among color channels and have predetermined colorimetry. The color correction process 10 includes the following steps:

Step 100: Start.

Step 110: Establish a channel-dependent Gain-Offset-Gamma (GOG) model to characterize an Electro-Optical Transfer Function (EOTF) of each primary color in which a gain parameter and a gamma parameter of each primary color vary with inputs of other two primary colors due to crosstalk among color channels.

Step 120: Measure the EOTF of each primary color when the other two primary colors are under different input conditions, and simulate the gain parameter and the gamma parameter of each primary color by use of a first surface function and a second surface function.

Step 130: Substitute inputs of the three primary colors into the first surface function and the second surface function to calculate the gain parameter and the gamma parameter of each primary color for further estimation of a non-linear EOTF of each primary color.

Step 140: Linearize the non-linear EOTF of each primary color through inverse transformation of the channel-dependent GOG model, and perform color correction according to a target colorimetry to obtain corrected values of the three primary colors.

Step 150: End.

According to the color correction process 10, the present invention firstly establishes the channel-dependent GOG model to characterize the EOTF of each primary color. The gain parameter and the gamma parameter of each primary color vary with inputs of other two primary colors due to crosstalk among color channels in this model. Then, the present invention measures the EOTF of each primary color when the other two primary colors are under different input conditions, and simulates the gain parameter and the gamma parameter of each primary color by use of a first surface function and a second surface function, respectively. In this situation, the present invention can substitute inputs of the three primary colors into the first surface function and the second surface function to calculate the gain parameter and the gamma parameter of each primary color for further estimation of a non-linear EOTF of each primary color.

Since different devices possess different display features, the same image may be in different colors on the different devices. Thus, the present invention further linearizes the non-linear EOTF of each primary color through the inverse transformation of the channel-dependent GOG model, to obtain color values which are irrelevant to the display devices. According to the target colorimetry, the color correction is undertaken to convert the linear EOTF to a target EOTF such that the expected color display can be obtained. Regarding detailed operations of the color correction process 10, please refer to the following statements.

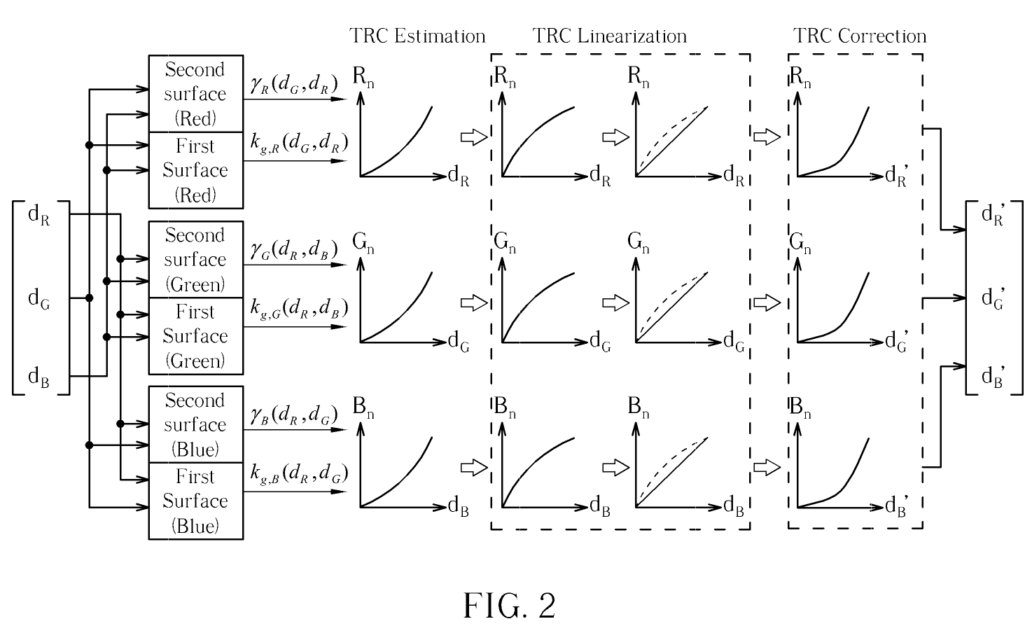

Please refer to FIG. 2, which is a schematic diagram of an embodiment of the color correction process 10 according to the present invention. In Step 110, the non-linear EOTF of each primary color is simulated by the channel-dependent GOG model, in which the gain parameter and the gamma parameter of each primary color vary with inputs of the other two primary colors due to crosstalk among color channels. Thus, the channel-dependent GOG model is given by:

$$\begin{matrix}{R}_{n} = {[ {k}_{g , R} ( {d}_{G} , {d}_{B} ) ( \frac{{d}_{R}}{{2}^{N} - 1} ) + ( 1 - {k}_{g , R} ( {d}_{G} , {d}_{B} ) ) ]}^{{γ}_{R} ( {d}_{G} , {d}_{B} )} , 0 \leq {R}_{n} \leq 1 & ( 1 ) \\ {G}_{n} = {[ {k}_{g , G} ( {d}_{R} , {d}_{B} ) ( \frac{{d}_{G}}{{2}^{N} - 1} ) + ( 1 - {k}_{g , G} ( {d}_{R} , {d}_{B} ) ) ]}^{{γ}_{G} ( {d}_{R} , {d}_{B} )} , 0 \leq {G}_{n} \leq 1 & ( 2 ) \\ {B}_{n} = {[ {k}_{g , B} ( {d}_{R} , {d}_{G} ) ( \frac{{d}_{B}}{{2}^{N} - 1} ) + ( 1 - {k}_{g , B} ( {d}_{R} , {d}_{G} ) ) ]}^{{γ}_{B} ( {d}_{B} , {d}_{G} )} , 0 \leq {B}_{n} \leq 1 & ( 3 )\end{matrix}$$

Where d_{R}, d_{G}, d_{B} denote inputs of the three primary colors, respectively; Rₙ, Gₙ, Bₙ denote normalized brightness of the three primary colors, respectively; k_{g,R}, k_{g,G}, k_{g,B} denote the gain parameters of the three primary colors, respectively; γ_{R}, γ_{G}, γ_{B} denote the gamma parameters of the three primary colors, respectively; and N denotes the number of input bits.

Since the gain parameter and the gamma parameter of each primary color vary with inputs of the other two primary colors due to crosstalk among color channels, the gain parameter and the gamma parameter of each primary color can thus be represented by a first surface function and a second surface function (i.e. two dimension function), respectively. In this situation, variance of the gain parameter or the gamma parameter of each primary color on a two dimension plane can be simulated by measuring the EOTF of each primary color when the other two primary colors are under different input conditions, so as to approximate coefficients of the first surface function and the second surface function (Step 120). For example, the gain parameter and the gamma parameter of a red primary color are given by:

γ_{R}(d_{G},d_{R})=a+b·d_{G}+c·d_{B}+d·d_{G}²+e·d_{B}²+f·d_{G}·d_{B} (4)

k_{g,R}(d_{G},d_{R})=g+h·d_{G}+i·d_{B}+j·d_{G}²+k·d_{B}²+l·d_{G}·d_{B} (5)

Where a˜f and g˜l are coefficients of the two dimension function optimally approximating to the actual parameter values. Please note that other surface functions can also be used for simulating variance of the gamma parameter and the gain parameter on the two dimension plane as long as differences between estimated parameter values and the actual parameter values are less than a predetermined threshold. Consequently, both of the gamma parameter and the gain parameter of the red primary color can be accurately estimated when the blue and green primary colors are under different input conditions.

In other words, after substituting the inputs of the three primary colors into the first surface function and the second surface function, the present invention can calculate the gain parameter and the gamma parameter of each primary color at this time for further characterization of the non-linear EOTF or the TRC of each primary color (Step 130), as shown in FIG. 2.

Due to different displays with different features, the same image may be seen in different colors. Thus, the non-linear EOTF of each primary color can further be linearized through the inverse transformation of the channel-dependent GOG model to obtain color values independent of the display devices. The inverse transformation of the channel-dependent GOG model is given by:

$$\begin{matrix}{d}_{R , output} = ( \frac{{2}^{N} - 1}{{k}_{g , R} ( {d}_{G} , {d}_{B} )} ) [ {( \frac{{d}_{R}}{{2}^{N} - 1} )}^{\frac{1}{{γ}_{R} ( {d}_{G} , {d}_{B} )}} - ( 1 - {k}_{g , R} ( {d}_{G} , {d}_{B} ) ) ] & ( 6 ) \\ {d}_{G , output} = ( \frac{{2}^{N} - 1}{{k}_{g , G} ( {d}_{R} , {d}_{B} )} ) [ {( \frac{{d}_{G}}{{2}^{N} - 1} )}^{\frac{1}{{γ}_{G} ( {d}_{R} , {d}_{B} )}} - ( 1 - {k}_{g , G} ( {d}_{R} , {d}_{B} ) ) ] & ( 7 ) \\ {d}_{B , output} = ( \frac{{2}^{N} - 1}{{k}_{g , B} ( {d}_{R} , {d}_{G} )} ) [ {( \frac{{d}_{B}}{{2}^{N} - 1} )}^{\frac{1}{{γ}_{B} ( {d}_{R} , {d}_{G} )}} - ( 1 - {k}_{g , B} ( {d}_{R} , {d}_{G} ) ) ] & ( 8 )\end{matrix}$$

Where d_{R,output}, d_{G,output}, d_{B,output} denote outputs, individually, generated by inversely transforming the channel-dependent GOG model with the inputs of each primary color, which are irrelevant to the colorimetry of the LCD.

Since the linearized EOTF is irrelevant to the colorimetry of the LCD (i.e. the crosstalk existing among the three primary colors has been eliminated), the linear EOTF can then be converted to a target EOTF according to the target colorimetry, as shown in FIG. 2, so as to get expected color display on the LCD. That is, for the color correction, the present invention can further substitute the above outputs of each primary color into the target EOTF to obtain corrected values of each primary color. This can be expressed by:

$$\begin{matrix}{d}_{R}^{′} = {( {2}^{N} - 1 ) [ {k}_{gT , R} ( \frac{{d}_{R , output}}{{2}^{N} - 1} ) + ( 1 - {k}_{gT , R} ) ]}^{{γ}_{T , R}} & ( 9 ) \\ {d}_{G}^{′} = {( {2}^{N} - 1 ) [ {k}_{gT , G} ( \frac{{d}_{G , output}}{{2}^{N} - 1} ) + ( 1 - {k}_{gT , G} ) ]}^{{γ}_{T , G}} & ( 10 ) \\ {d}_{B}^{′} = {( {2}^{N} - 1 ) [ {k}_{gT , B} ( \frac{{d}_{B , output}}{{2}^{N} - 1} ) + ( 1 - {k}_{gT , B} ) ]}^{{γ}_{T , B}} & ( 11 )\end{matrix}$$

Where k_{gT,R}, k_{gT,R}, k_{gT,R} denote target gain parameters of each primary color, respectively; γ_{T,R}, γ_{T,G}, γ_{T,B} denote target gamma parameters of each primary color, respectively; and d_{R}′, d_{G}′, d_{B}′ denote the corrected values of each primary color, respectively.

If the colormetry of the LCD is intended to meet the sRGB standard, the target gain parameter and the target gamma parameter are set to 1.0 and 2.2. Then, the aforementioned equations can be rewritten by:

$$\begin{matrix}{d}_{R}^{′} = ( {2}^{N} - 1 ) {( \frac{{d}_{R , output}}{{2}^{N} - 1} )}^{2.2} & ( 12 ) \\ {d}_{G}^{′} = ( {2}^{N} - 1 ) {( \frac{{d}_{G , output}}{{2}^{N} - 1} )}^{2.2} & ( 13 ) \\ {d}_{B}^{′} = ( {2}^{N} - 1 ) {( \frac{{d}_{B , output}}{{2}^{N} - 1} )}^{2.2} & ( 14 )\end{matrix}$$

In summary, the non-linear EOTF of the LCD can be accurately estimated by the channel-dependent GOG model when there exists crosstalk among the color channels, so that the non-linear EOTF can be converted to the apparatus-independent linear EOTF and further to the target EOTF for obtaining the expected performance on color display.

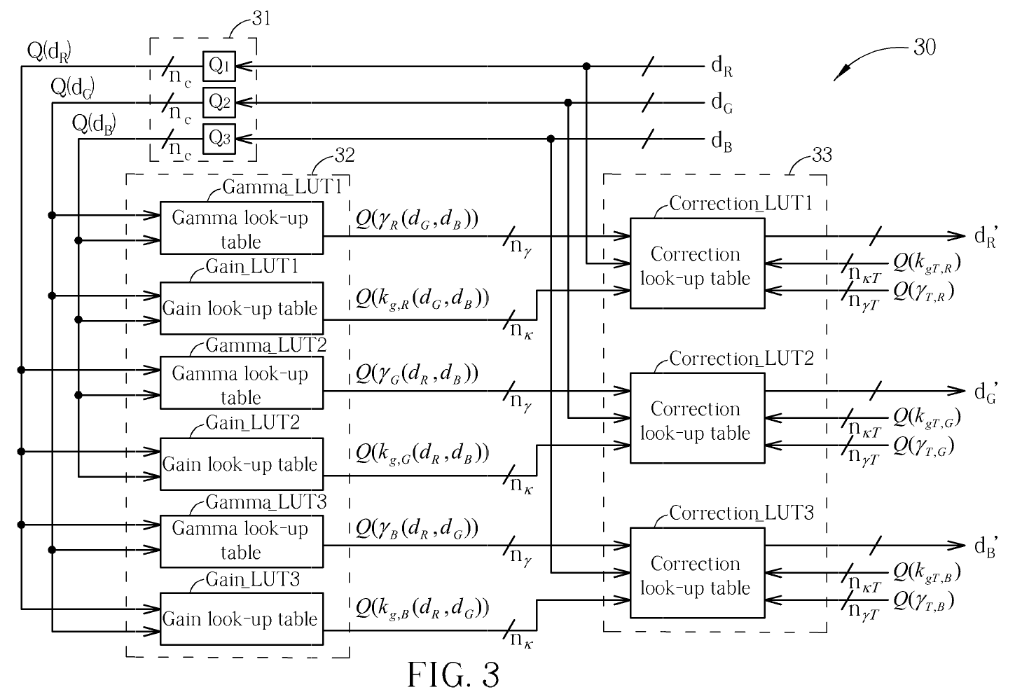

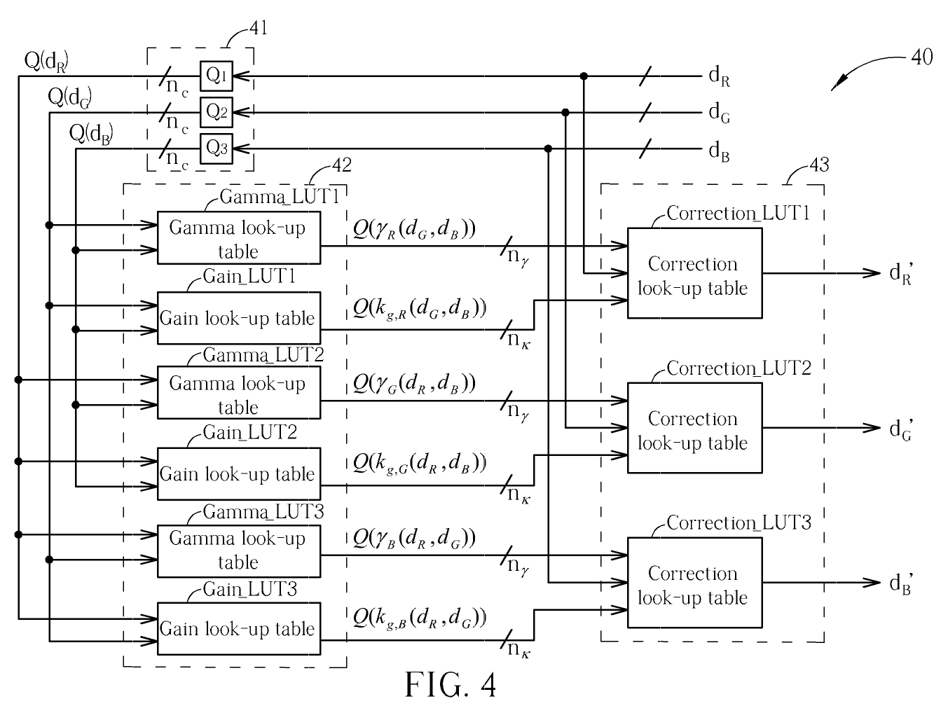

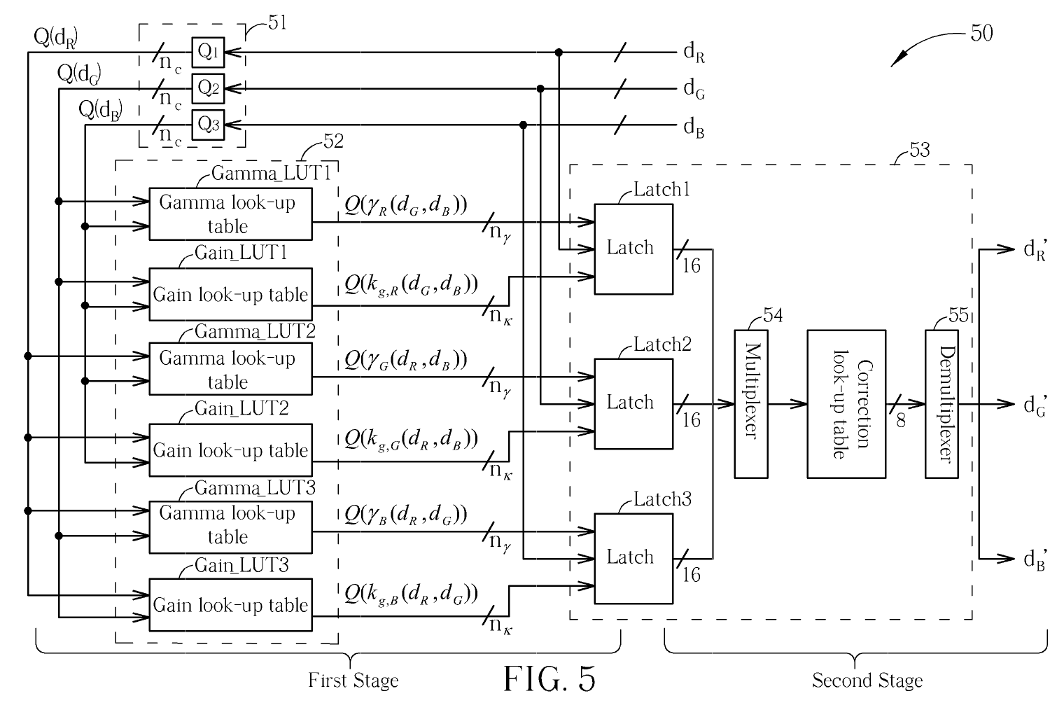

Please refer to FIG. 3, which is a schematic diagram of a color correction device 30 for an LCD according to an embodiment of the present invention. The color correction device 30 is used for realizing the color correction process 10, and includes a quantization unit 31, an estimation unit 32 and a correction unit 33. The quantization unit 31 includes quantizers Q1˜Q3 for quantizing inputs of the three primary colors to adjust down the resolution for reduction of memory demand. The estimation unit 32 is coupled to the quantization unit 31, and is used for performing look-up table operations on quantization results of the inputs of each primary color to generate the gain parameter and the gamma parameter of each primary color for estimation of a non-linear EOTF of each primary color. The correction unit 33 is coupled to input terminals of the quantization unit 31 and the estimation unit 32, and is used for performing color correction on the inputs of the three primary colors according to the gain parameter and the gamma parameter outputted from the estimation unit 32 to generate corrected values of the three primary colors meeting a target colorimetry.

The estimation unit 32 further includes gamma look-up tables Gamma_LUT1˜Gamma_LUT3 and gain look-up tables Gain_LUT1˜Gain_LUT3. The gamma look-up tables Gamma_LUT1˜Gamma_LUT3 are used for storing all possible values of the gamma parameter of each primary color, generated from all possible results of quantizing the other two primary colors. The gain look-up tables Gain_LUT1˜Gain_LUT3 are used for storing all possible values of the gain parameter of each primary color, generated from all possible results of quantizing the other two primary colors.

That is to say, the present invention calculates all possible values of the gain and the gamma parameters in advance by the aforementioned two dimension surface function and stores the quantization results into the gamma look-up tables Gamma_LUT1˜Gamma_LUT3 and the gain look-up tables Gain_LUT1˜Gain_LUT3. Taking the red primary color for example, the contents, stored in the gamma look-up table Gamma_LUT1, include values of the gamma parameter corresponding to all possible results of quantizing inputs of the blue and green primary color, which is expressed by:

γ_{R}(\hat{d}_{G},\hat{d}_{B})=a+b·\hat{d}_{G}+c·\hat{d}_{B}+d·\hat{d}_{G}²+e·\hat{d}_{B}²+f·\hat{d}_{G}·\hat{d}_{B} (15)

Where d\hat{_{G}}=Q⁻¹(Q(d_{G})) denotes the quantization results of d_{G}; and Q(d_{G}) denotes the quantization index of d_{G}. Likewise, the contents, stored in the gain look-up table, include values of the gamma parameter corresponding to all possible results of quantizing inputs of the blue and green primary color, which is expressed by:

k_{g,R}(\hat{d}_{G},\hat{d}_{B})=g+h·\hat{d}_{G}+i·\hat{d}_{B}+j·\hat{d}_{G}²+k·\hat{d}_{B}²+l·\hat{d}_{G}·\hat{d}_{B} (16)

On the other hand, the correction unit 33 further includes correction look-up tables Correction_LUT1˜Correction_LUT3 for storing all calculation results of the color correction for all possible inputs of the three primary colors. Taking the red primary color for example, the correction look-up table Correction_LUT1 includes all calculation results, provided by linearizing the TRC and modifying the TRC to the target TRC with parameters such as quantization parameters (\hat{γ}_{R}(\hat{d}_{G},\hat{d}_{B}),\hat{k}_{g,R}(\hat{d}_{G},\hat{d}_{B})) outputted from the gamma look-up table Gamma_LUT1 and the gain look-up table Gain_LUT1, all possible inputs of the red primary color d_{R} and all possible values of the target parameters (k_{gT,R}, γ_{T,R}), which can be expressed by combining eq. (6) and (9):

$${d}_{R}^{′} = ( {2}^{N} - 1 ) \times {[ \frac{{k}_{gT , R}}{{\hat{k}}_{g , R} ( {\hat{d}}_{G} , {\hat{d}}_{B} )} ( {( \frac{{d}_{R}}{{2}^{N} - 1} )}^{\frac{1}{{\hat{γ}}_{R} ( {\hat{d}}_{G} , {\hat{d}}_{B} )}} - 1 + {\hat{k}}_{g , R} ( {\hat{d}}_{G} , {\hat{d}}_{B} ) ) + 1 - {k}_{gT , R} ]}^{{γ}_{T , B}} \qquad$$

For example, if each primary color is quantized to 16 steps (n_{c}=4), each primary color has 256 possible sets of the gain parameter and the gamma parameter which can be calculated in advance by the aforementioned two dimension surface function. Then, calculation results are quantized to n_{γ} bits and nₖ bits, respectively and stored in the gamma look-up tables and the gain look-up tables. In this situation, if the gamma and the gain parameters from the gamma and gain look-up tables are also quantized to 16 steps (n_{γ}=4,nₖ=4), assuming there are four possible sets of the target gamma and gain parameters (n_{γT}=2,n_{kT}=2), 1 million bytes of memory capacity will be required for the correction look-up table. However, 256 bytes memory is enough for both the gamma look-up table and the gain look-up table when n_{c}=4.

If there is only one set of the target gamma and gain parameters, for example, one set meeting the sRGB standard (i.e. the target gain parameter k_{gT} and the target gamma parameter γ_{T} of each primary color are set to 1.0 and 2.2, respectively), the color correction device 30 of FIG. 3 can be simplified as a color correction device 40 shown in FIG. 4 according to an embodiment of the present invention. In this situation, taking the red primary color for example, the correction look-up table Correction_LUT1 includes all calculation results, provided by linearizing the TRC and modifying the TRC to the target TRC with parameters such as quantization parameters (\hat{γ}(\hat{d}_{G},\hat{d}_{B}), \hat{k}_{g,R}(\hat{d}_{G},\hat{d}_{B})) outputted from the gamma look-up table Gamma_LUT1 and the gain look-up table Gain_LUT1 and all possible inputs of the red primary color d_{R}, which can be expressed by combining eq. (6) and (12):

$${d}_{R}^{′} = ( {2}^{N} - 1 ) \times {[ \frac{1}{{\hat{k}}_{g , R} ( {\hat{d}}_{G} , {\hat{d}}_{B} )} ( {( \frac{{d}_{R}}{{2}^{N} - 1} )}^{\frac{1}{{\hat{γ}}_{R} ( {\hat{d}}_{G} , {\hat{d}}_{B} )}} - 1 + {\hat{k}}_{g , R} ( {\hat{d}}_{G} , {\hat{d}}_{B} ) ) ]}^{2.2} \qquad$$

In this situation, if the gamma and gain parameters from the gamma and gain look-up tables are quantized to 16 steps (n_{γ}=4,nₖ=4), only 64 bytes memory is required for the correction look-up table.

Moreover, if the target gamma parameter and the target gain parameter of each primary color are the same and data access time of the LUT memory is less than one-third of each pixel input cycle, the color correction device 40 shown in FIG. 4 can further be modified as a two-stage pipeline structure as shown in FIG. 5 according to an embodiment of the present invention. In this case, required memory capacity is only one-third of the embodiment of FIG. 4.

To sum up, the present invention utilizes the gamma and gain parameters of the GOG model to estimate and model the channel interactions or crosstalk among three primary colors, so that accurate results of the electro-optical conversion can be obtained. Therefore, the color management can be undertaken by using apparatus-independent color values to achieve the expected color display.

Those skilled in the art will readily observe that numerous modifications and alterations of the device and method may be made while retaining the teachings of the invention.

What is claimed is:

1. A color correction method for eliminating crosstalk between color channels of a liquid crystal displays (LCD), the color correction method comprising:
establishing a channel-dependent Gain-Offset-Gamma (GOG) model to characterize an Electro-Optical Transfer Function (EOTF) of each primary color in which a gain parameter and a gamma parameter of each primary color vary with inputs of other two primary colors due to crosstalk between color channels;
measuring the EOTF of each primary color when the other two primary colors are under different input conditions, and simulating the gain parameter and the gamma parameter of each primary color by use of a first surface function and a second surface function;
substituting inputs of the three primary colors into the first surface function and the second surface function to calculate the gain parameter and the gamma parameter of each primary color for further estimation of a non-linear EOTF of each primary color; and
linearizing the non-linear EOTF of each primary color through inverse transformation of the channel-dependent GOG model, and performing color correction according to a target colorimetry to obtain corrected values of the three primary colors.

2. The color correction method of claim 1, wherein the EOTF of each primary color is a tone reproduction curve (TRC).

3. The color correction method of claim 1 further comprising:
quantizing the inputs of the three primary colors.

4. The color correction method of claim 3, wherein substituting the inputs of the three primary color into the first surface function and the second surface function to calculate the gain parameter and the gamma parameter of each primary color further comprises:
substituting all possible quantization results of the other two primary colors into the first surface function and the second surface function to calculate all possible values of the gain parameter and the gamma parameter of each primary color.

5. The color correction method of claim 4, wherein the gain parameter and the gamma parameter of each primary color are stored as a first bit amount and a second bit amount in a lookup table memory, respectively.

6. The color correction method of claim 4, wherein linearizing the non-linear EOTF of each primary color through the inverse transformation of the channel-dependent GOG model and performing the color correction according to the target colorimetry to obtain the corrected values of the three primary colors further comprises:
calculating the corrected values of the three primary colors according to all possible values of the gain parameter and the gamma parameter of each primary color, the inputs of each primary color, and a gain parameter and a gamma parameter of each primary color corresponding to the target colorimetry.

7. The color correction method of claim 1, wherein linearizing the non-linear EOTF of each primary color through the inverse transformation of the channel-dependent GOG model and performing the color correction according to the target colorimetry to obtain the corrected values of the three primary colors comprises:
performing the inverse transformation of the channel-dependent GOG model on the input of each primary color according to the non-linear EOTF of each primary color to generate an output irrelevant to the LCD, the output allowing each primary color of the LCD to have a linear EOTF; and
substituting the output into a target EOTF corresponding to the target colorimetry to obtain the corrected value of one of the three primary colors.

8. The color correction method of claim 7, wherein the target EOTF is generated by a target gain parameter and a target gamma parameter.

9. The color correction method of claim 1, wherein the target colorimetry meets an sRGB standard.

10. A color correction device for eliminating crosstalk between color channels of a liquid crystal displays (LCD), the color correction device comprising:
a quantization unit for individually quantizing inputs of three primary colors;
an estimation unit, coupled to the quantization unit, for performing look-up table operation according to quantization results of the inputs of each primary color to generate a gain parameter and a gamma parameter of each primary color for further estimation of a non-linear Electro-Optical Transfer Function (EOTF) of each primary color, wherein the gain parameter and the gamma parameter of each primary color vary with the inputs of the other two primary colors due to crosstalk between color channels, the estimation unit comprising:
at least one gamma look-up table (LUT) for storing all possible values of the gamma parameter of each primary color under conditions of all possible quantization results of the other two primary colors; and
at least one gain LUT for storing all possible values of the gain parameter of each primary color under conditions of all possible quantization results of the other two primary colors; and
a correction unit, coupled to input terminals of the quantization unit and the estimation unit, for performing color correction on the input of each primary color according to the gain parameter and the gamma parameter of each primary color to generate corrected values of the three primary colors meeting a target colorimetry, the correction unit comprising:
at least one correction LUT for storing all calculation results of the color correction for all possible inputs of the three primary colors.

11. The color correction device of claim 10, wherein the quantization unit further comprises three quantizers.

12. The color correction device of claim 10, wherein the gain parameter and the gamma parameter of each primary color are stored as a first bit amount and a second bit amount in the at least one gain LUT and the at least one gamma LUT, respectively.

13. The color correction device of claim 10, wherein all possible values of the gain parameter and the gamma parameter of each primary color are obtained by substituting all possible quantization results into a first surface function and a second surface function corresponding to the gain parameter and the gamma parameter, respectively, the firs surface function and the second surface function being generated by measuring inherent colorimetry of the LCD via a channel-dependent Gain-Offset-Gamma (GOG) model.

14. The color correction device of claim 10, wherein the correction unit performs the color correction on the input of each primary color according to a target gain parameter and a target gamma parameter of each primary color.

15. The color correction device of claim 14, wherein the target gain parameter and the target gamma parameter of the three primary colors are identical.

16. The color correction device of claim 15, wherein the correction unit comprises one correction LUT.

17. The color correction device of claim 10, wherein the correction unit linearizes the non-linear EOTF of each primary color via inverse transformation of the channel-dependent GOG model, and performs the color correction according to the target colorimetry to obtain the corrected values of the three primary colors.

18. The color correction device of claim 10, wherein the target colorimetry meets an sRGB standard.
